(19) United States
(12) Patent Application Publication
(10) Pub. No.: US 2010/0045688 A1
(43) Pub. Date: Feb. 25, 2010

(54) Dynamic Image Control Device Using Coincident Blank Insertion Signals

(75) Inventors: Tien-Chu Hsu, Taoyuan (TW); Yu-An Liu, Taoyuan (TW)

Correspondence Address: VENABLE LLP, P.O. BOX 34385, WASHINGTON, DC, 20043-9998, US

(73) Assignee: CHUNGHWA PICTURE TUBES, LTD., Taoyuan (TW)

(21) Appl. No.: 12/197,634

(22) Filed: Aug. 25, 2008

(51) Int. Cl. G09G 5/36

(52) U.S. Cl. 345/545

(57) ABSTRACT

An image control device has display signals and blank insertion (BI) signals. Polarities of the display signals and those of the BI signals are coincident. Thus, BI signals are displayed in a way of 1+2 line inversion and differences of response times are eliminated to avoid affecting MPRT

### FIELD OF THE INVENTION

The present invention relates to image control device; more particularly, relates to displaying BI signals in a way of 1+2 line inversion for coinciding polarities of BI data with those of display data, where differences of response times are thus eliminated to avoid affecting MPRT.

### DESCRIPTION OF THE RELATED ART

Blank insertion (BI) is usually used to improve screen quality. With the BI data, integration effect of image to human eye is eliminated and Image sticking of LCD TV is solved. However, the BI data are written in with the same polarities at one time, which are not coincident with the display data. Thus, response times of neighboring pixels may not be coincident and pixel color may be come in correct.

Generally, a few continuous gate lines are opened to be written with BI data at one time. That is, a few horizontal lines are continuously opened to be mixed among normal display data. As shown in FIG. 11, the four horizontal data 50, 51, 52, 53 are displayed at the bottom of the screen. Another four horizontal lines are opened at the same time for writing in blank data at the upper side of the screen. Thus, one BI data is added after every four horizontal data 50, 51, 52, 53 with a frequency improved for 1.25 times (i.e. (4+1)/4).

This method is easily used in designing Tcon; but is not so fit for horizontal polarities. Four lines are opened at one time and signals having the same polarities are written in simultaneously, which is a way different from 1+2 line inversion for writing in original display data with corresponding polarities. Thus, response times may be affected and inconsistent. Hence, the prior art does not fulfill all users' requests on actual use.

### SUMMARY OF THE INVENTION

The main purpose of the present invention is to display BI signals in a way of 1+2 line inversion for coinciding polarities of display data with those of BI data, where differences of response times are thus eliminated to avoid affecting MPRT.

To achieve the above purpose, the present invention is a dynamic image control device using coincident BI signals, comprising a sequence control unit for controlling timing sequence data; a data access unit connecting to the sequence control unit for accessing required data; a buffer unit connecting to the data access unit for buffering the required data; a register connecting to the sequence control unit for buffering the timing sequence data; a memory unit connecting to the register for storing the timing sequence settings; a data output unit connecting to the sequence control unit and the data access unit for outputting data; and a driving signal unit connecting to the data sequence control unit and the register for outputting driving signals, where the driving signal unit outputs a STH signal, a TP signal, a POL signal, a STV signal, a VCLK signal and a plurality of OE signals; control waveform of each of the TP signal, the POL signal, the STV signal, the VCLK signal and the OE signal is divided into a display section and a BI section; the VCLK signal in the display section comprises cyclic signals and each of the cyclic signal comprises sequential signals of a first VCLK pulse signal and a second VCLK pulse signal; the STV signal in the display section is a high level signal at the second VCLK pulse signal; the OE signal in the display section comprises cyclic signals and each of the cyclic signal comprises sequential signals of a first OE low potential signal, an OE high potential signal and a second OE low potential signal; the VCLK signal in the BI section comprises cyclic signals and each of the cyclic signal comprises sequential signals of a first VCLK pulse signal and a second VCLK pulse signal; the STV signal in the BI section is a high level signal during the second VCLK pulse signal of a cyclic signal of the VCLK signal and the first VCLK pulse signal of next cyclic signal of the VCLK signal; and the OE signal in the BI section comprises cyclic signals and each of the cyclic signal comprises sequential signals of a first OE high potential signal, an OE low potential signal and a second OE high potential signal. Accordingly, a novel dynamic image control device using coincident BI signals is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is the view showing the structure according to the present invention;

FIG. 2 is the view showing the control waveforms of the first preferred embodiment;

FIG. 3 is the view showing the waveforms of the display section of the first preferred embodiment;

FIG. 4 is the view showing the waveforms of the BI section of the first preferred embodiment;

FIG. 5 is the view showing the polarities of the first preferred embodiment;

FIG. 6 is the view showing the waveforms of the first preferred embodiment;

FIG. 7 is the view showing the waveforms of the display section of the second preferred embodiment;

FIG. 8 is the view showing the waveforms of the BI section of the second preferred embodiment;

FIG. 9 is the view showing the polarities of the second preferred embodiment;

FIG. 10 is the view showing the waveforms of the second preferred embodiment; and

FIG. 11 is the view of the general BI section.

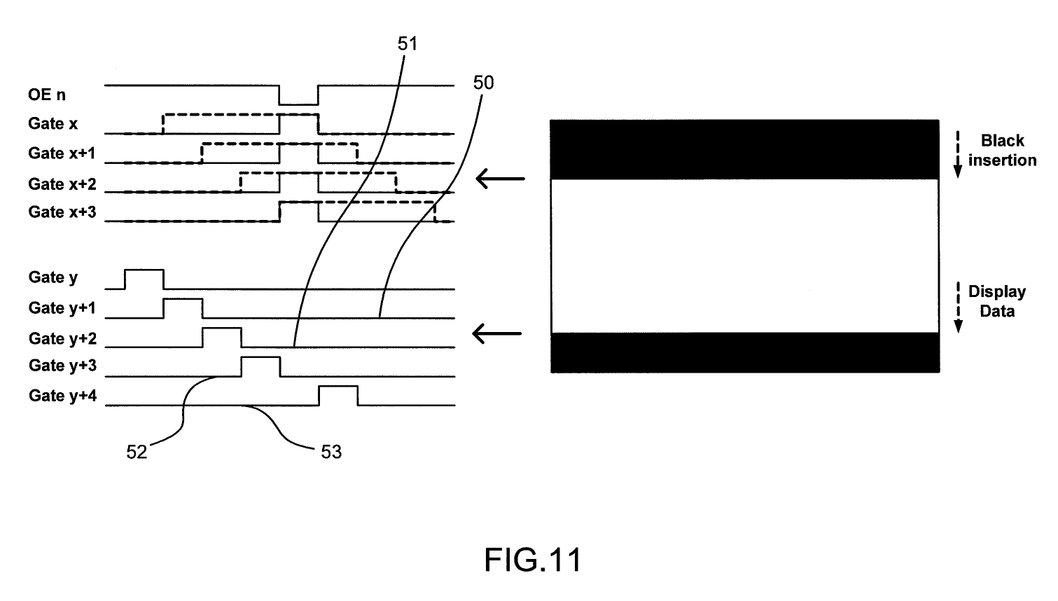

### DESCRIPTIONS OF THE PREFERRED EMBODIMENTS

The following descriptions of the preferred embodiments are provided to understand the features and the structures of the present invention.

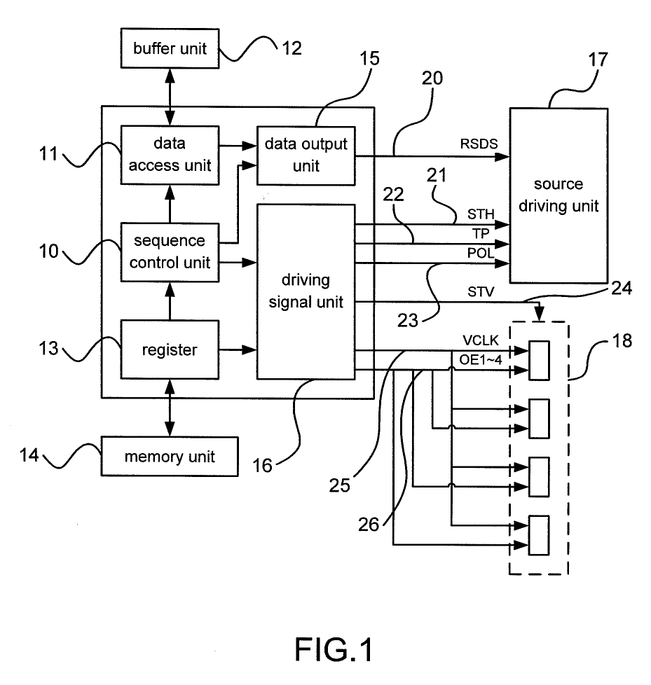

Please refer to FIG. 1, which is a view showing a structure according to the present invention. As shown in the figure, the present invention is a dynamic image control device using coincident blank insertion (BI) signals, comprising a sequence control unit 10, a data access unit 11, a buffer unit 12, a register 13, a memory unit 14, a data output unit 15 and a driving signal unit 16.

The sequence control unit 10 controls timing sequence data.

The data access unit 11 is connected with the sequence control unit 10 to access required data.

The buffer unit 12 is connected with the data access unit 11 to buffer the required data.

The register 13 is connected with the sequence control unit 10 to buffer the timing sequence data.

The memory unit 14 is connected with the register to store the timing sequence data.

The data output unit 15 is connected with the sequence control unit 10 and the data access unit 11 to output data. And the data output unit 15 is connected with a source driving unit 17 to output a reduced swing differential signal (RSDS).

The driving signal unit 16 is connected with the sequence control unit 10 and the register 13 to output driving signals. And the driving signal unit 16 is connected with the source driving unit 17 to output a STH signal 21, a TP signal 22 and a POL signal 23; and is connected with a gate driving unit 18 to output a STV signal 24, a VCLK signal 25 and a plurality of OE signals 26. The TP signal 22 is a transference control signal for the source driving unit 17. And the source driving unit 17 transfers crystal signals to pixels of a horizontal line while activating the TP signal 22. The POL signal 23 is a polarity control signal for output signals of the source driving unit 17, where an output signal is shown as high for a positive polarity or is shown as low for a negative polarity. The STV signal 24 is a start pulse for the register 13 (a shift register) in the gate driving unit 18. On activating the STV signal 24, each horizontal line is opened sequentially along with the VCLK signal 25 and the OE signal 26. The VCLK signal 25 is a trigger signal to the register 13, where, on activating the VCLK signal 25, a value in the register 13 in the gate driving unit 15 is shifted and the OE signal 26 controls openings of horizontal lines. The OE signal 26 is an output control signal for the gate driving unit 18. When the OE signal 26 is shown as ‘high’, output of the gate driving unit 18 is disabled because an output of a horizontal line is forced to have potential too low to be opened for signaling pixels. On the contrary, when the OE signal 26 is shown as ‘low’, the register 13 is at a high position and a high potential is outputted to a horizontal line for writing display signals by the source driving unit 17. Thus, with the above structure, a novel dynamic image control device using coincident blank insertion signals is obtained.

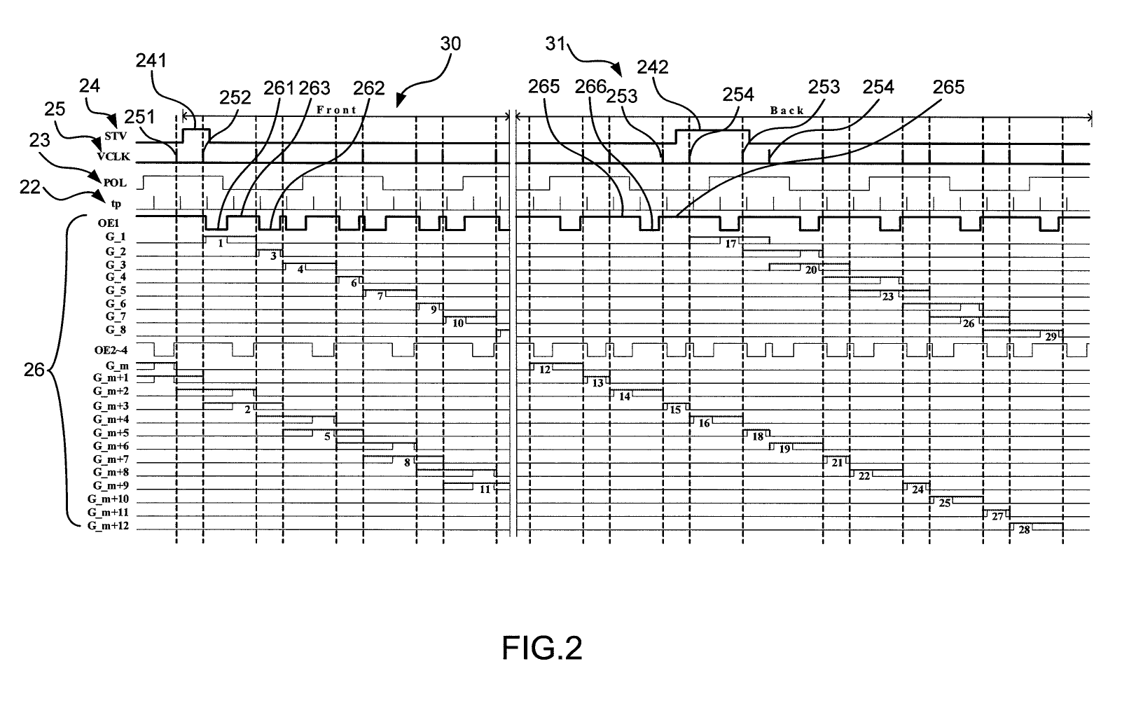

Please refer to FIG. 2 to FIG. 6, which are a view showing control waveforms of a first preferred embodiment; views showing waveforms of a display section and a BI section of the first preferred embodiment; a view showing polarities of the first preferred embodiment; and a view showing waveforms of the first preferred embodiment. As shown in the figures, control waveform of each of a TP signal, a POL signal, an STV signal, a VCLK signal and an OE signal is divided into a display section 30 and a BI section

The VCLK signal 25 in the display section 30 comprises cyclic signals and each cyclic signal comprises sequential signals of a first VCLK pulse signal 251 and a second VCLK pulse signal 252. The STV signal 24 in the display section 30 is a high level signal 241 in the second VCLK pulse signal 252. The OE signal 26 in the display section 30 comprises cyclic signals and each cyclic signal comprises sequential signals of a first OE low potential signal 261, an OE high potential signal 263 and a second OE low potential

The VCLK signal 25 in the BI section 31 comprises cyclic signals and each cyclic signal comprises sequential signals of a first VCLK pulse signal 253 and a second VCLK pulse signal 254. The STV signal 24 in the BI section 31 is a high level signal 242 during the second VCLK pulse signal 254 of a cyclic signal of the VCLK signal 25 and the first VCLK pulse signal 253 of next cyclic signal of the VCLK signal 25. The OE signal 26 in the BI section 31 comprises cyclic signals and each cyclic signal comprises sequential signals of a first OE high potential signal 264, an OE low potential signal 266 and a second OE high potential signal 265.

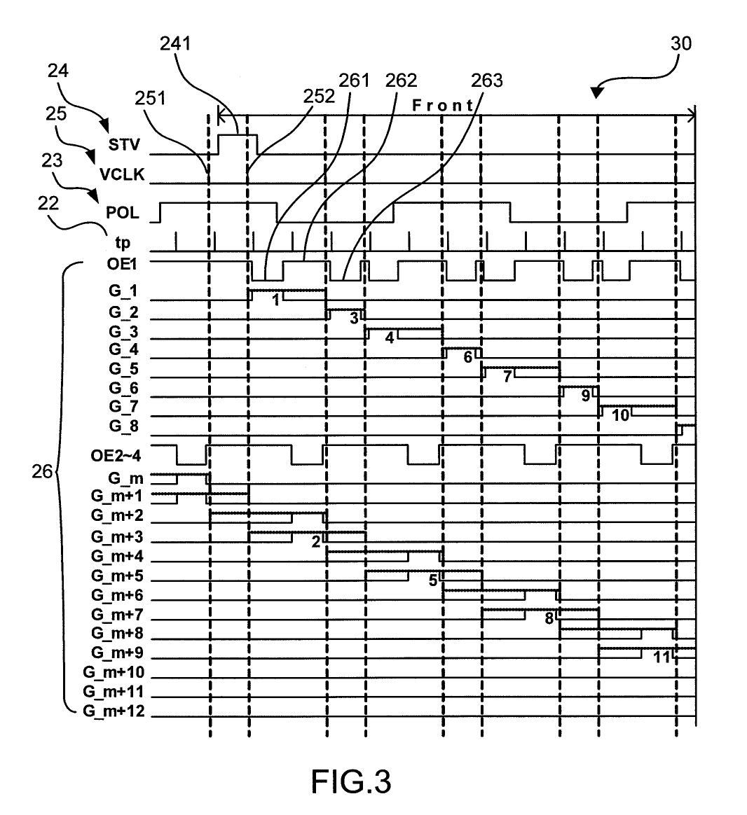

The display section 30 displays signals. When the STV signal 24 is triggered by the VCLK signal 25 for displaying the signals, all gates except the first gate are cyclically opened for two time periods together with an interval of one time period through controls by the VCLK signal 25 and the OE signal 26. As shown in FIG. 3, the gates are sequentially opened from the first line at time periods 1, 3, 4, 6, 7, 9, 10, and so forth; and data are written in to be display with polarities of 1+2 line inversion. In a prior half of the display section 30, two gates are opened every two time periods on a specific position of a screen at time periods 2, 5, 8, 11, and so forth; and blank data are written in with coincident polarities, which are the BI signals from a latter half of the previous frame.

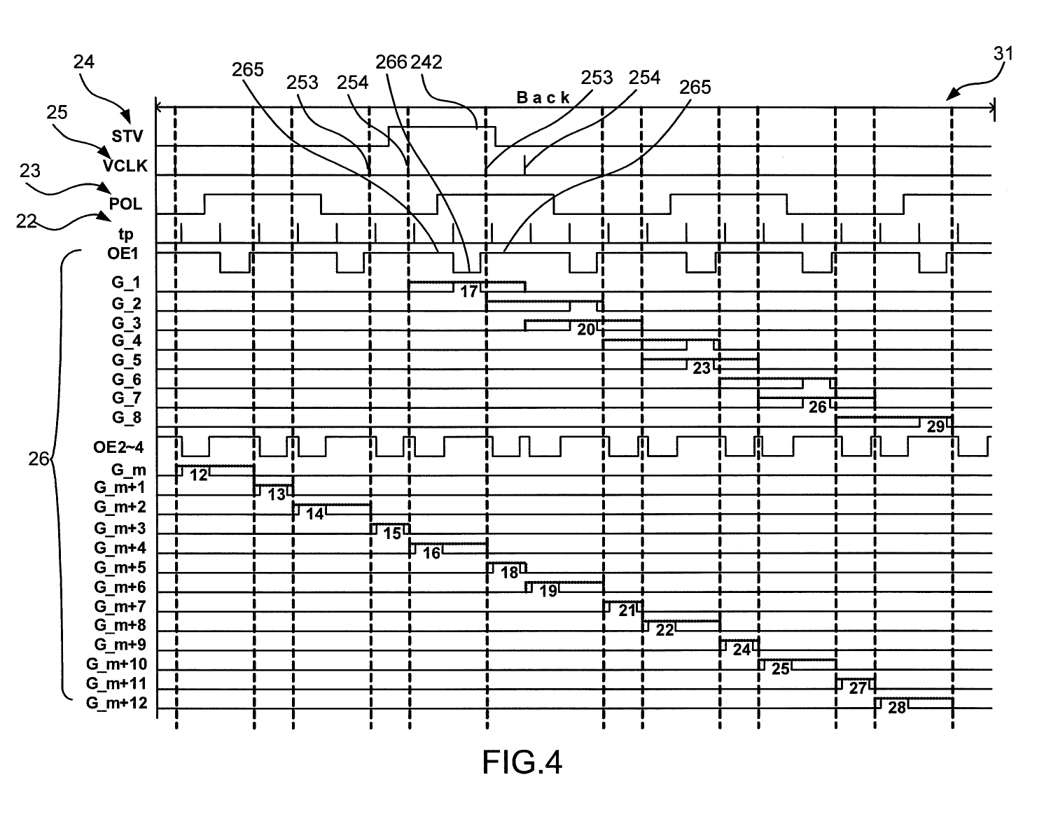

The BI section 31 comprises BI signals, whose STV signal 24 crosses two VCLK signals 25. Under control by the VCLK signal 25, the OE signal 26 and the POL signal 23, all gates except the first gate are cyclically opened for two time periods together with an interval of one time period. As shown in FIG. 4, except the first and the last gates, all the gates are opened by two at time periods 17, 20, 23, 26, 29, and so forth; and BI signals are written in with coincident polarities. And, gates are opened to write in display signals at time periods 12, 13, 14, 15, 16, 18, 19, 21, 22, 24, 25, 27, 28, and so forth. Thus, with the above structure, the display signals and the BI signals use the same source driving unit 17 simultaneously.

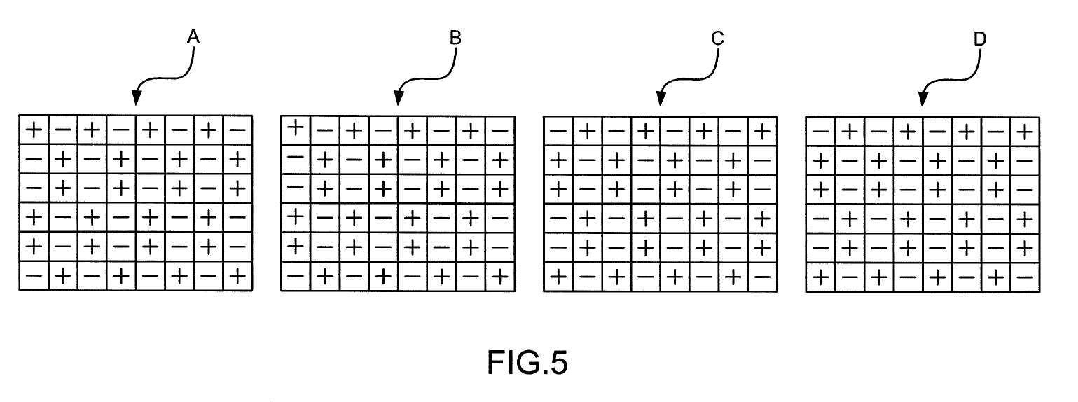

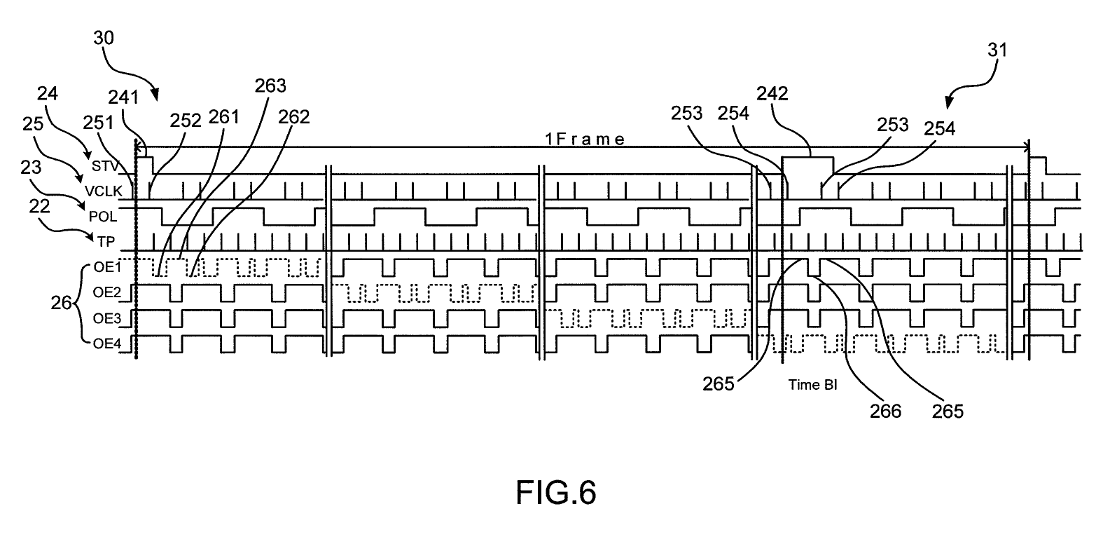

As shown in FIG. 5, polarities of screen A, B, C and D are the same both in the BI section and in the display section. As shown in FIG. 6, the dotted-line parts of the OE signal 26 are display signals, switching from OE1 to OE4 for displaying a frame. The other parts of the OE signal 26 are BI signals. Time BI in FIG. 6 is the start time for BI, whose position is changeable but not for the dotted-line parts of OE1. When Time BI has a different position, the screen has a different rate of BI accordingly. The number of OE signals is unlimited but has to be greater than two. In this way, with two time periods for horizontal display signal and one time period for horizontal BI signal, display frequency is improved for (2+1)2=1.5 times.

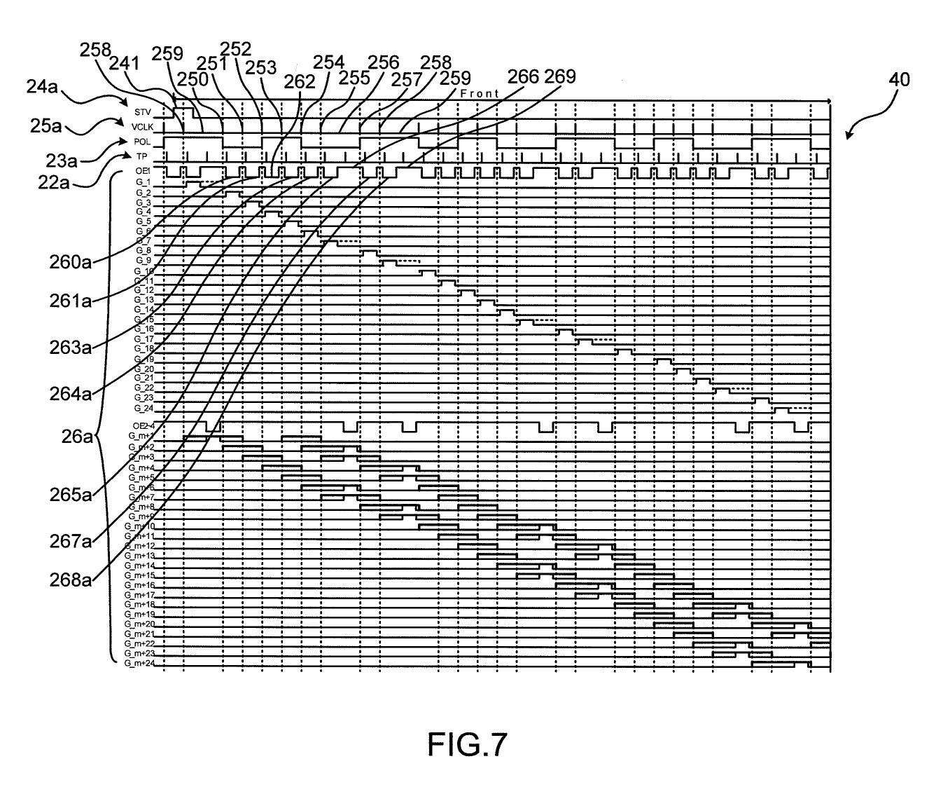

Please refer to FIG. 7 to FIG. 10, which are views showing waveforms of a display section and a BI section of a second preferred embodiment; and views showing polarities and waveforms of the second preferred embodiment. As shown in the figures, a VCLK signal 25a in a display section 40 comprises cyclic signals and each cyclic signal comprises sequential signals of a first VCLK pulse signal 250a, a second VCLK pulse signal 251a, a third VCLK pulse signal 252a, a fourth VCLK pulse signal 253a, a fifth VCLK pulse signal 254a, a sixth VCLK pulse signal 255a, a first low level signal 256a, a seventh VCLK pulse signal 257a, an eighth VCLK pulse signal 258a and a second low level signal 259a. An STV signal 24a in the display section 40 is a high level signal 241a at the eighth VCLK pulse signal 258a. An OE signal 26a in the display section 40 comprises cyclic signals and each cyclic signal comprises sequential signals of a first OE low potential signal 260a, a second OE low potential signal 261a, a third OE low potential signal 262a, a fourth OE low potential signal 263a, a fifth OE low potential signal 264a, a sixth OE low potential signal 265a, a first OE high potential signal 266a, a seventh OE low potential signal 267a, an eighth OE low potential signal 268a and a second OE high potential signal 269a.

A VCLK signal 25a in a BI section 41 comprises cyclic signals and each cyclic signal comprises sequential signals of a first VCLK pulse signal 250b, a second VCLK pulse signal 251b, a third VCLK pulse signal 252b, a fourth VCLK pulse signal 253b, a fifth VCLK pulse signal 254b, a sixth VCLK pulse signal 255b, a first low level signal 256b, a seventh VCLK pulse signal 257b, a eighth VCLK pulse signal 258b and a second low level signal 259b. An STV signal 24a in the BI section 41 is a high level signal 240b during the eighth VCLK pulse signal 258b of a cyclic signal of the VCLK signal 25a and the first VCLK pulse signal 250b of next cyclic signal of the VCLK signal 25a; and is a high level signal 241b during the fourth VCLK pulse signal 253b of the next cyclic signal of the VCLK signal 25a and the fifth VCLK pulse signal 254b of the next cyclic signal of the VCLK signal 25a. An OE signal 26a in the BI section 41 comprises cyclic signals and each cyclic signal comprises sequential signals of a first OE high potential signal 260b, a second OE high potential signal 261b, a third OE high potential signal 262b, a fourth OE high potential signal 263b, a fifth OE high potential signal 264b, a sixth OE high potential signal 265b, a first OE low potential signal 266b, a seventh OE high potential signal 267b, an eighth OE high potential signal 268b, and a second OE low potential signal 269b.

FIG. 7 shows control waveforms of input part of the display section 40. After the STV signal 24a is triggered by the VCLK signal 25a, all gates except the first gate are cyclically opened for six time periods or two time periods together with an interval of one time period to write in display signals line by line through controls by the VCLK signal 25a and the OE signal 26a. A display of 1+2 line inversion is obtained with a design of a POL signal 23a, where four gates are processed with BI action at a certain position on a screen during the interval.

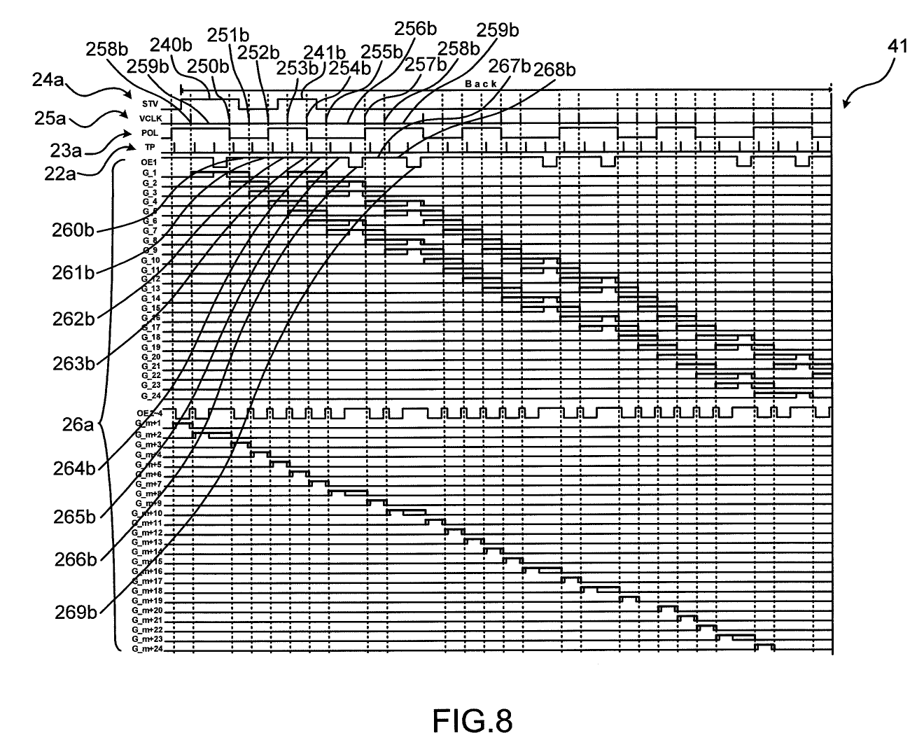

As shown in FIG. 8, the STV signal 24a in the BI section comprises a high level signal 240b crossing two VCLK signals 25a (having an interval of a VCLK signal wide between the two signals); a low level signal crossing two VCLK signals 25a; and a high level signal 241b crossing two VCLK signals 25a. Through controls by the VCLK signal 25a and the OE signal 26a, all gates except the first gate are cyclically opened for six time periods or two time periods. And four gates are opened at one time to write in BI signals with the same polarities, where data are simultaneously displayed at a certain position on a screen during the interval.

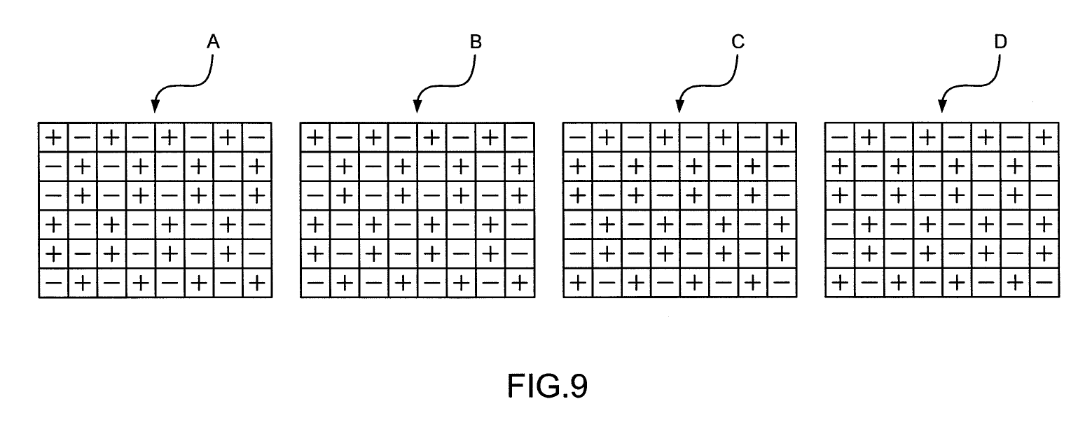

FIG. 9 shows polarities of screens. Polarities of screen A, B, C and D are coincident no mater in the BI section or in the display section.

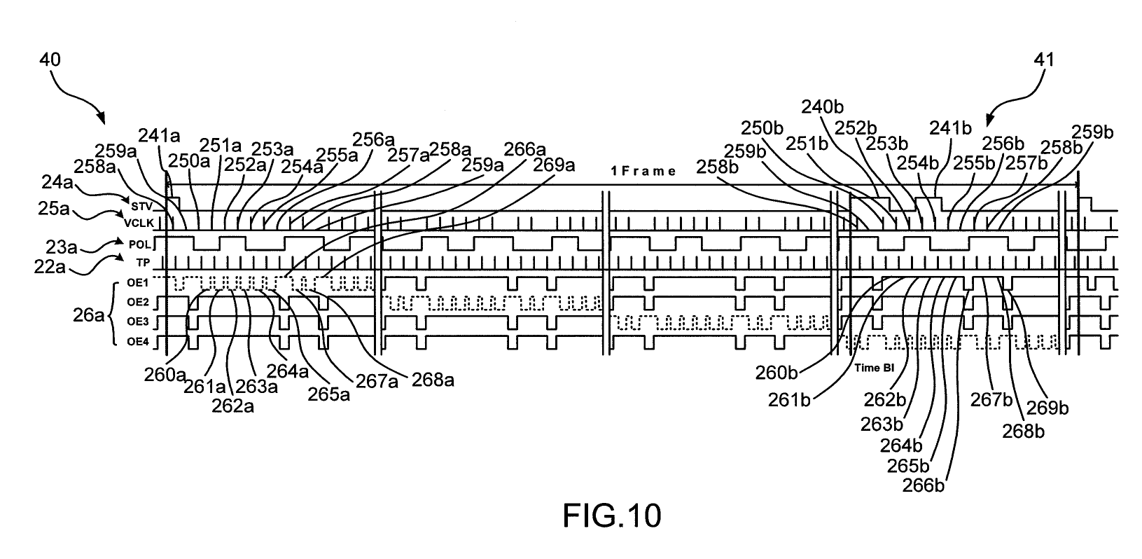

As shown in FIG. 10, dotted-line parts of the OE signal 26a are the parts for displaying data and the other parts are for BI, where the dotted-line parts are shifted from OE1 through OE4 and are followed by displaying the data to finish a frame. When a certain position of the screen is processed with the displaying, BI signal is opened with four lines at one time for a BI of 1+2 line inversion. When start time of the Time BI is different, BI on the screen has a different ratio; but the BI is not processed at the dotted-line parts. The number of signals in the OE signal 26a (number of integrated circuits) is not limited yet greater than two, which comprises four time periods for horizontal display signal and one time period for horizontal BI signal with display frequency improved for (4+1)/4=1.25 times

To sum up, the present invention is a dynamic image control device using coincident BI signals, where MPRT of a board is reduced through using BI technology; BI signals are displayed in a way of 1+2 line inversion with STV, VCLK and OE control signals for coinciding polarities of display data with those of BI data; and differences of response times for displaying data are thus eliminated.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A dynamic image control device using coincident blank insertion (BI) signals, comprising:
a sequence control unit, said sequence control unit controlling timing sequence data;
a data access unit, said data access unit connecting to said sequence control unit, said data access unit accessing required data;
a buffer unit, said buffer unit connecting to said data access unit, said buffer unit buffering said required data;
a register, said register connecting to said sequence control unit, said register buffering said timing sequence data;
a memory unit, said memory unit connecting to said register, said memory unit storing said timing sequence settings;
a data output unit, said data output unit connecting to said sequence control unit and said data access unit, said data output unit outputting data; and
a driving signal unit, said driving signal unit connecting to said data sequence control unit and said register, said driving signal unit outputting driving signals.

2. The device according to claim 1 wherein said data output unit is connected with a source driving unit; and
wherein said data output unit outputs a reduced swing differential signal (RSDS) to said source driving unit.

3. The device according to claim 1, wherein said driving signal unit is connected with a source driving unit and a gate driving unit;
wherein said driving signal unit outputs a STH signal, a TP signal and a POL signal to said source driving unit; and
wherein said driving signal unit outputs a STV signal, a VCLK signal and a plurality of OE signals to said gate driving unit.

4. A dynamic image control device using coincident BI signals, comprising:
a sequence control unit, said sequence control unit controlling timing sequence data;
a data access unit, said data access unit connecting to said sequence control unit, said data access unit accessing required data;
a buffer unit, said buffer unit connecting to said data access unit, said buffer unit buffering said required data;
a register, said register connecting to said sequence control unit, said register buffering said timing sequence data;
a memory unit, said memory unit connecting to said register, said memory unit storing said timing sequence settings;
a data output unit, said data output unit connecting to said sequence control unit and said data access unit, said data output unit outputting an RSDS signal; and
a driving signal unit, said driving signal unit connecting to said data sequence control unit and said register, said driving signal unit outputting a STH signal, a TP signal, a POL signal, a STV signal, a VCLK signal and a plurality of OE signals,
wherein control waveform of each of said TP signal, said POL signal, said STV signal, said VCLK signal and said OE signal is divided into a display section and a BI section;
wherein said VCLK signal in said display section comprises cyclic signals and each cyclic signal comprises sequential signals of a first VCLK pulse signal and a second VCLK pulse signal;
wherein said STV signal in said display section is a high level signal at said second VCLK pulse signal;
wherein said OE signal in said display section comprises cyclic signals and each cyclic signal comprises sequential signals of a first OE low potential signal, an OE high potential signal and a second OE low potential signal;
wherein said VCLK signal in said BI section comprises cyclic signals and each cyclic signal comprises sequential signals of a first VCLK pulse signal and a second VCLK pulse signal;
wherein said STV signal in said BI section is a high level signal during said second VCLK pulse signal of a cyclic signal of said VCLK signal and said first VCLK pulse signal of next cyclic signal of said VCLK signal; and
wherein said OE signal in said BI section comprises cyclic signals and each cyclic signal comprises sequential signals of a first OE high potential signal, an OE low potential signal and a second OE high potential signal sequentially.

5. The device according to claim 4, wherein said RSDS signal, said STH signal, said TP signal and said POL signal are outputted to a source driving unit.

6. The device according to claim 4, wherein said STV signal, said VCLK signal and said plurality of OE signals are outputted to a gate driving unit.

7. A dynamic image control device using coincident BI signals, comprising:
a sequence control unit, said sequence control unit controlling timing sequence data;
a data access unit, said data access unit connecting to said sequence control unit, said data access unit accessing required data;
a buffer unit, said buffer unit connecting to said data access unit, said buffer unit buffering said required data;
a register, said register connecting to said sequence control unit, said register buffering said timing sequence
a memory unit, said memory unit connecting to said register, said memory unit storing said timing sequence settings;
a data output unit, said data output unit connecting to said sequence control unit and said data access unit, said data output unit outputting an RSDS signal; and
a driving signal unit, said driving signal unit connecting to said data sequence control unit and said register, said driving signal unit outputting a STH signal, a TP signal, a POL signal, a STV signal, a VCLK signal and a plurality of OE signals,
wherein control waveform of each of said TP signal, said POL signal, said STV signal, said VCLK signal and said OE signal is divided into a display section and a BI section;
wherein said VCLK signal in said display section comprises cyclic signals and each cyclic signal comprises sequential signals of a first VCLK pulse signal, a second VCLK pulse signal, a third VCLK pulse signal, a fourth VCLK pulse signal, a fifth VCLK pulse signal, a sixth VCLK pulse signal, a first low level signal, a seventh VCLK pulse signal, an eighth VCLK pulse signal and a second low level signal;
wherein said STV signal has a high level at said eighth VCLK pulse signal;
wherein said OE signal in said display section comprises cyclic signals and each cyclic signal comprises sequential signals of a first OE low potential signal, a second OE low potential signal, a third OE low potential signal, a fourth OE low potential signal, a fifth OE low potential signal, a sixth OE low potential signal, a first OE high potential signal, a seventh OE low potential signal, an eighth OE low potential signal, and a second OE high potential signal;
wherein said VCLK signal in said BI section comprises cyclic signals and each cyclic signal comprises sequential signals of a first VCLK pulse signal, a second VCLK pulse signal, a third VCLK pulse signal, a fourth VCLK pulse signal, a fifth VCLK pulse signal, a sixth VCLK pulse signal, a first low level signal, a seventh VCLK pulse signal, a eighth VCLK pulse signal and a second low level signal;
wherein said STV signal in said BI section is a high level signal during said eighth VCLK pulse signal of a cyclic signal of said VCLK signal and said first VCLK pulse signal of next cyclic signal of said VCLK signal;
wherein said STV signal in said BI section is a high level during said fourth VCLK pulse signal of said next cyclic signal of said VCLK signal and said fifth VCLK pulse signal of said next cyclic signal of said VCLK signal; and
wherein said OE signal in said BI section comprises cyclic signals and each cyclic signal comprises sequential signals of a first OE high potential signal, a second OE high potential signal, a third OE high potential signal, a fourth OE high potential signal, a fifth OE high potential signal, a sixth OE high potential signal, a first OE low potential signal, a seventh OE high potential signal, an eighth OE high potential signal, and a second OE low potential signal sequentially.

8. The device according to claim 7, wherein said RSDS signal, said STH signal, said TP signal and said POL signal are outputted to a source driving unit.

9. The device according to claim 7, wherein said STV signal, said VCLK signal and said plurality of OE signals are outputted to a gate driving unit.
